(19) United States
(12) Patent Application Publication
(10) Pub. No.: US 2026/0312867 A1
(43) Pub. Date: Oct. 8, 2026

(54) METHOD FOR ESTABLISHING AND/OR RUNNING A NETWORK WITH MULTIPLE NETWORK DEVICES WITH NFC TAGS

(71) Applicant: HIRSCHMANN AUTOMATION AND CONTROL GMBH, Neckartenzlingen (DE)

(72) Inventors: Jonas GLASS, Riederich (DE); Markus SEEHOFER, Rechberghausen (DE); Dennis LICKAY, Böblingen (DE)

(73) Assignee: HIRSCHMANN AUTOMATION AND CONTROL GMBH, Neckartenzlingen (DE)

(21) Appl. No.: 19/482,643

(22) PCT Filed: May 8, 2024
(86) PCT No.: PCT/EP2024/062784

§ 371 Date: Nov. 7, 2025

(30) Foreign Application Priority Data
May 10, 2023 (DE) 10 2023 112 365.3

(51) Int. Cl. H04L 41/0806; H04W 12/47

(52) U.S. Cl. CPC H04L 41/0806; H04W 12/47

(57) ABSTRACT

In a method for establishing and/or running a network with multiple network devices which are connected together and communicate with one another, wherein each network has a storage means at least with configuration data for the function thereof in the network, wherein at least one network device, preferably each network device of the network, has a readable identification means, wherein, during the planning of the network and/or the exchange of a network device in a network that is already running, the configuration data are allocated to the identification means, wherein, after the identification means of the network device have been read, the configuration data of this network device are allocated to the latter upon initial start-up or during the use of a new network device after exchange of a defective network device, wherein the identification means itself does not store the configuration data, but rather configuration data stored thereby are located and retrieved for transmission to the network device.

### DESCRIPTION

The invention relates to a method for creating and/or operating a network with a plurality of network devices which are connected to one another and communicate with one another, in accordance with the features of the generic term of claim 1.

When creating a network, the functions of the individual network devices are pre-planned without these functions already being configured on the new network devices that are to be installed. It is therefore necessary to simplify the installation of the configuration to enable the functions of the network device when the network is set up with these network devices.

When operating a network, there is a need to record the existing configuration of the defective network device and transfer it to the new, as yet unconfigured network device in the event of a defective network device, its replacement and the subsequent replacement of the defective network device with a new network device.

The invention relates to the object of providing a method for creating a network or a method for operating a network, with which the configuration of a network device is simplified but at the same time carried out securely.

The object is achieved by the features of claim 1.

According to the invention, it is provided that at least one network device, preferably each network device, has a readable identification means, wherein the configuration data is assigned to the identification means during the planning of the network and/or the replacement of a network device in an already operated network, wherein, after the identification means of the network device has been read out, its configuration data is assigned to this network device during initial commissioning or when a new network device is used after a defective network device has been replaced, wherein the identification means itself does not store the configuration data, but can be used to find the configuration data stored at another location (such as an external storage, a network management station or similar) and call it up for transfer to the network device. Once the network device has been identified, called up and transferred, the configuration data required for this network device is stored in the storage thereof.

During initial commissioning, the configuration data can be transferred to the new network device from a suitable storage medium that is connected to it. It is also conceivable that the new network device, which already has a basic configuration, retrieves the configuration data required for the planned network from a network management station or a comparable device.

The same applies to a replaced network device. This can also be connected to a storage medium from which the configuration data is loaded onto the exchanged network device. Alternatively (or additionally if necessary), the configuration data from the new network device can be retrieved from a network management station via the network that is already in operation.

In particular, an NFC tag can be used as a means of identification on the network device. Such an NFC tag placed in or on the network device can be accessed from an external device such as a notebook, a smartphone, a tablet or a comparable device. This also has the advantage that such devices are provided with storage in which the configuration files to be transferred are saved beforehand. Once the external device, which is preferably a mobile device, has identified the network device using the NFC tag, the configuration data can be transferred from its storage to the network device wirelessly or by wire (either during initial commissioning or after replacement). After this transfer, the network device can accept the configuration data received and start operating with it. This can be done automatically after the configuration data has been transferred in full or, if necessary, only after a start command.

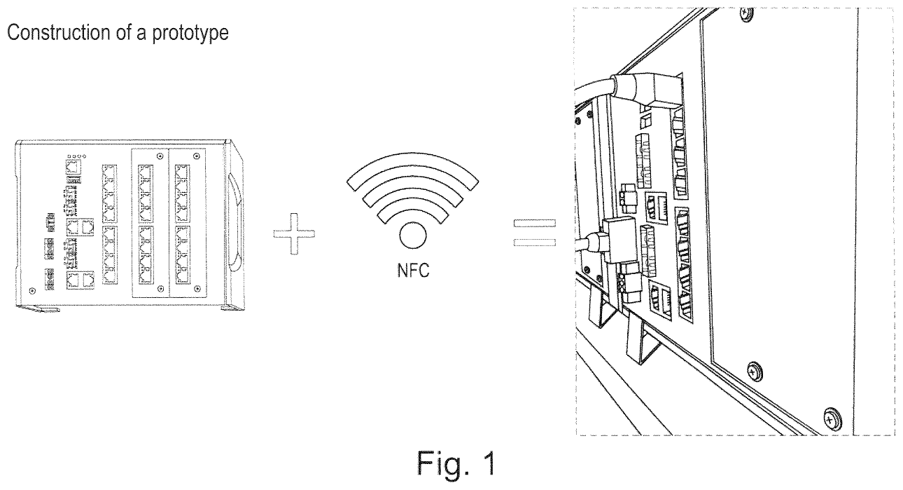

In FIGS. 1 to 4, the method according to the invention is shown and is briefly described as follows.

FIG. 1 shows a network device, in particular a switch, with an NFC tag on the left. The right-hand image in FIG. 1 shows the switch in operation in a network not shown further, which has the usual data lines via which at least two switches, in practice often a significantly higher number of switches, are connected to one another and exchange data. In addition or as an alternative, wireless data connections can also be considered.

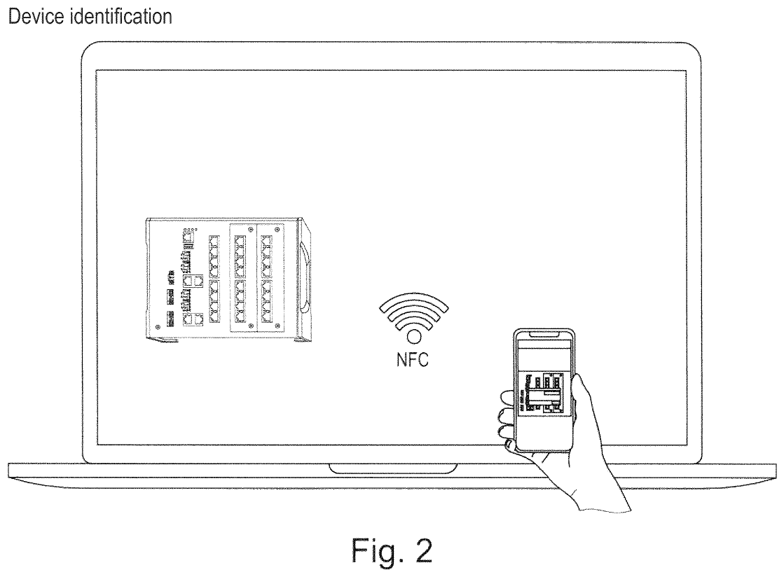

FIG. 2 shows an example of how the identification means of the network device shown in FIG. 1 can be addressed by a notebook or smartphone via a wireless connection (here using NFC). The device (notebook, smartphone or similar) is used to identify the addressed network device using its means of identification (in this case the NFC tag).

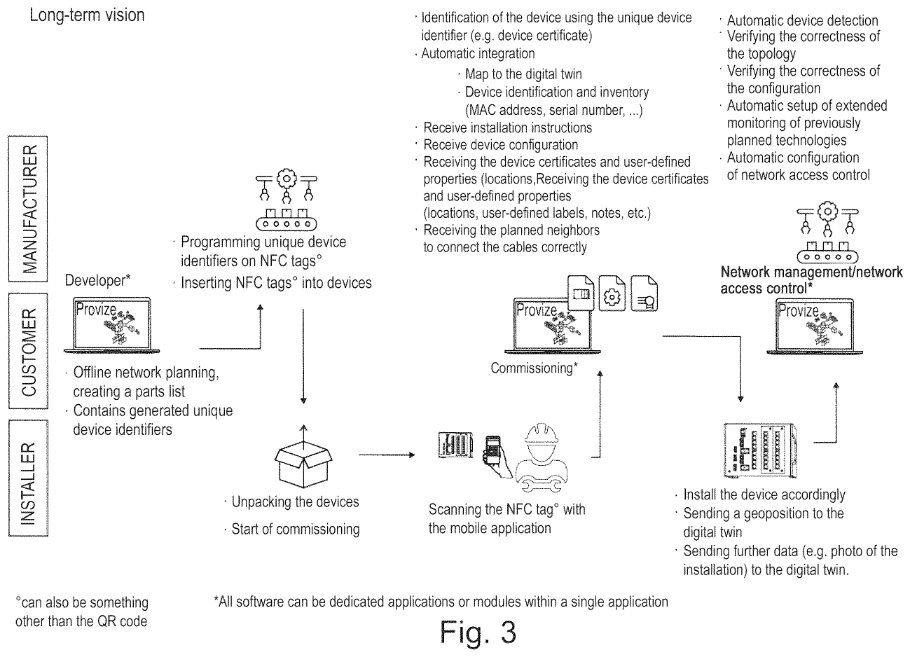

FIG. 3 shows the sequence from the planning of a network to the use of a new network device with an identification device. This means of identification is read out using a suitable device and the configuration data to be transferred to the network device is selected using the identification data read out and retrieved from a suitable storage medium. The selected configuration data is then transferred to the network device and stored there in the network device's storage medium.

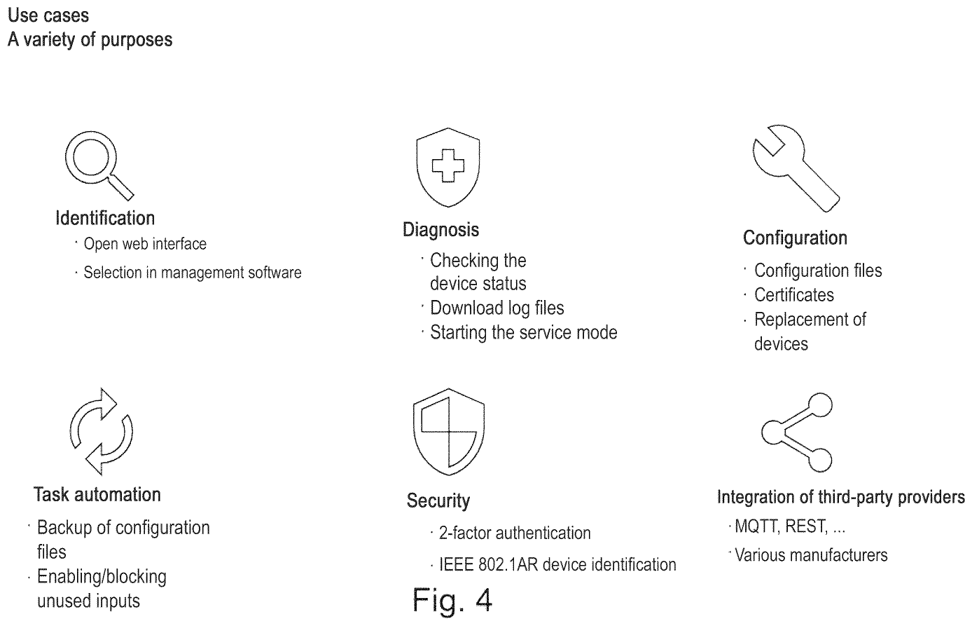

FIG. 4 shows various applications of the method according to the invention with regard to identification, diagnosis, configuration, automation, security and use of the method by third parties.

1. A method for establishing and/or running a network with multiple network devices which are connected together and communicate with one another, wherein each network has a storage means at least with configuration data for the function thereof in the network, wherein at least one network device, preferably each network device of the network, has a readable identification means, wherein, during the planning of the network and/or the exchange of a network device in a network that is already running, the configuration data are allocated to the identification means, wherein, after the identification means of the network device have been read, the configuration data of this network device are allocated to the latter upon initial start-up or during the use of a new network device after exchange of a defective network device, wherein the identification means itself does not store the configuration data, but rather configuration data stored thereby are located and retrieved for transmission to the network device.

2. The method according to claim 1, wherein an NFC tag is used as an identification means on the network device,

3. The method according to claim 1, wherein the identification means, in particular an NFC tag arranged in or on the network device, is called up by an external device such as a notebook, a smartphone, a tablet or a comparable device.

4. The method according to claim 1, wherein the method is applicable to each network device in the network.

5. The method according to claim 1, wherein after the external device, preferably the mobile device, has identified the network device by means of the identification means, in particular the NFC tag, the configuration data is transferred from its storage wirelessly or by wire to the network device either on initial start-up or after replacement.

6. The method according to claim 1, wherein after transmission of the configuration data, the network device takes over the configuration data received and starts operating with it.

7. The method according to claim 6, wherein operation is started automatically after the configuration data have been transmitted in full.

8. The method according to claim 6, wherein operation is only started after a start command.
